(19) United States
(12) Patent Application Publication
(10) Pub. No.: US 2020/0333699 A1
(43) Pub. Date: Oct. 22, 2020

(54) LIGHT SOURCE APPARATUS AND IMAGE PROJECTION APPARATUS

(71) Applicant: CANON KABUSHIKI KAISHA, Tokyo (JP)

(72) Inventors: Hiroshi Yamamoto, Ageo-shi (JP); Yuya Kurata, Utsunomiya-shi (JP); Kimiya Hoshino, Utsunomiya-shi (JP)

(21) Appl. No.: 16/845,261

(22) Filed: Apr. 10, 2020

(30) Foreign Application Priority Data
Apr. 18, 2019 (JP) 2019-078975
Mar. 31, 2020 (JP) 2020-061936

(51) Int. Cl. G03B 21/20; G02B 27/28; G02B 27/14; G02B 5/30; G02B 5/02; H04N 9/31

(52) U.S. Cl. CPC G03B 21/2013; G03B 21/204; G03B 21/2073; G02B 27/283; H04N 9/3158; G02B 5/3083; G02B 5/0205; H04N 9/3167; G02B 27/141

(57) ABSTRACT

A light source apparatus includes a first light source configured to emit light in a first wavelength band, a second light source configured to emit light in a second wavelength band different from the first wavelength band, a light amount ratio changer configured to change a light amount ratio between a first polarized light component and a second polarized light component in light of the first wavelength band, a polarization beam splitter configured to split the first polarized light component and the second polarized light component, a wavelength converter configured to convert the light of the first wavelength band obtained from the first polarized light component, into light in a third wavelength band including the second wavelength band, and a light combiner configured to combine light in the first wavelength band and light in the second wavelength band with each other.

### BACKGROUND OF THE INVENTION

### Field of the Invention

The present invention relates to a light source apparatus suitable for an image projection apparatus (referred to as a projector hereinafter) using a wavelength conversion element, such as a phosphor or fluorescent member.

### Description of the Related Art

Japanese Patent Laid-Open No. (“JP”) 2015-106130 discloses a projector that can project and display a color image using a phosphor that converts part of blue light from a semiconductor laser (LD) into green light and red light.

A red light amount generated from the phosphor is often smaller than a green light amount. Thus, in order to display a white image, it is necessary to reduce the green and blue light amounts for the smallest red light amount among the red light, the green light and the blue light. At this time, the light use efficiency lowers because parts of the green light and the blue light are discarded which would otherwise be able to be used to display an image.

### SUMMARY OF THE INVENTION

The present invention provides a light source apparatus that can improve light use efficiency in projecting an image.

A light source apparatus according to one aspect of the present invention includes a first light source configured to emit light in a first wavelength band, a second light source configured to emit light in a second wavelength band different from the first wavelength band, a light amount ratio changer configured to change a light amount ratio between a first polarized light component and a second polarized light component having different polarization directions in light of the first wavelength band, a polarization beam splitter configured to split the first polarized light component and the second polarized light component from the light amount ratio changer, a wavelength converter configured to convert the light of the first wavelength band obtained from the first polarized light component from the polarization beam splitter, into light in a third wavelength band including the second wavelength band, and a light combiner configured to combine light in the first wavelength band and light in the second wavelength band with each other.

An image projection apparatus including the above light source apparatus also constitutes another aspect of the present invention.

Further features of the present invention will become apparent from the following description of exemplary embodiments with reference to the attached drawings.

### BRIEF DESCRIPTION OF THE DRAWINGS

FIGS. 1A and 1B illustrate a configuration of a projector according to a first embodiment of the present invention and a spectral characteristic of a first dichroic mirror.

FIGS. 2A and 2B illustrate a configuration of a projector according to a second embodiment of the present invention, and a spectral characteristic of a third dichroic mirror.

FIG. 3 illustrates a configuration of a projector according to a third embodiment of the present invention.

FIG. 4 is a flowchart showing processing performed in the projector according to the third embodiment.

FIG. 5 illustrates a configuration of a projector according to a fourth embodiment of the present invention.

FIG. 6 is a flowchart showing processing performed in the projector according to a fourth embodiment.

### DESCRIPTION OF THE EMBODIMENTS

Referring now to the accompanying drawings, a detailed description will be given of embodiments according to the present invention.

### First Embodiment

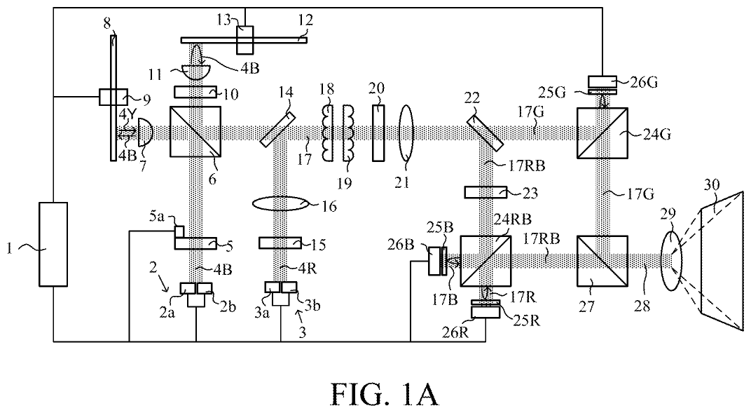

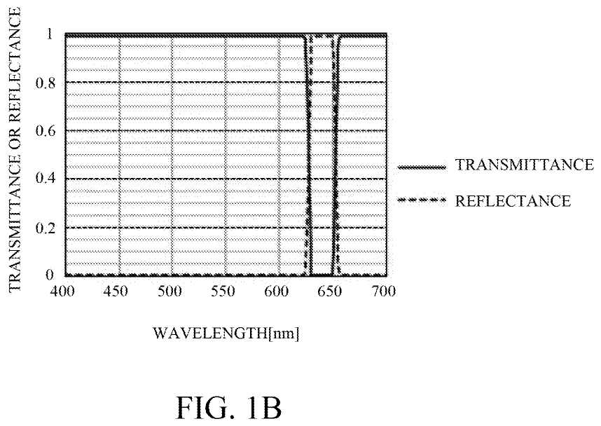

FIG. 1A illustrates a configuration of a projector as an image projection apparatus including a light source apparatus according to a first embodiment of the present invention. In the following description, R, G, and B represent red, green, and blue, respectively. The projector has a blue light source 2 and a red light source 3. The blue light source 2 emits blue light 4B, and the red light source 3 emits red light 4R. The projector includes a first retardation plate 5, a retardation plate motor 5a, a polarization beam splitter (“PBS”) 6, a first lens 7, a phosphor wheel 8, a phosphor wheel motor 9, a second retardation plate 10, a second lens 11, a diffusion wheel 12, a diffusion wheel motor 13, a first dichroic mirror 14, a diffusion plate 15, and a third lens 16. A light source apparatus includes the components from the blue light source 2 and the red light source 3 to the third lens 16 described above. Illumination light 17 is emitted from the light source apparatus.

The projector further includes a first fly-eye lens 18, a second fly-eye lens 19, a polarization conversion element 20, a fourth lens 21, a second dichroic mirror 22, and a wavelength selective phase plate 23. In addition, the projector further includes an RB polarization beam splitter 24RB, a G polarization beam splitter 24G, an R quarter waveplate 25R, a G quarter waveplate 25G, and a B quarter waveplate 25B. An illumination optical system includes from the first fly-eye lens 18 to the quarter waveplates 25R, 25G, and 25B described above.

The projector further includes an R light modulation element 26R, a G light modulation element 26G, a B light modulation element 26B, a color combining prism 27, a projection lens (projection optical system) 29, and a controller 1. The controller 1 includes a computer such as a CPU, and controls the entire projector according to a computer program, which includes the blue light source 2, the red light source 3, the retardation plate motor 5a, the phosphor wheel motor 9 the diffusion wheel motor 13, and the light modulation elements 26R, 26G, and 26B. The controller 1 is a component of the projector and forms part of the light source apparatus.

Both the blue light source 2 and the red light source 3 include semiconductor lasers (LDs). In this embodiment, the blue light source 2 includes two blue LDs 2a and 2b, and the red light source 3 includes two red LDs 3a and 3b. The number of each color LD may be one or three or more. The blue light source 2 has a peak wavelength of 455 nm, and the red light source 3 has a peak wavelength of 640 nm. The blue light source 2 emits blue light (light in a first wavelength band) 4B as P-polarized light, and the red light source 3 emits red light (light in a second wavelength band) as P-polarized light whose polarization direction is orthogonal to the S-polarized light.

The blue light 4B emitted from the blue light source 2, which is the first light source, enters the first retardation plate 5. The first retardation plate 5 as the light amount ratio changer serves as a half waveplate for the blue light 4B. The optical axis of the first retardation plate 5 is oriented in a direction intersecting with the polarization direction of the blue light 4B incident on the first retardation plate 5. The optical axis of the first retardation plate 5 here may be a fast axis or a slow axis. The first retardation plate 5 is rotatable around an axis extending in the traveling direction of the blue light 4B by the retardation plate motor 5a. The S-polarized light component as the first polarized light component and the P-polarized light component as the second polarized light component included in the blue light 4B emitted from the first retardation plate 5 or a light amount ratio can be changed by rotating the first retardation plate 5.

The blue light 4B emitted from the first retardation plate 5 enters the PBS 6 (polarization beam splitter). The PBS 6 has a polarization splitting surface having wavelength selectivity. This polarization splitting surface reflects the S-polarized component of the blue light 4B and transmits the P-polarized component. The polarization splitting surface transmits light in a wavelength band different from that of the blue light 4B regardless of the polarization direction. A light amount ratio between the reflected light (S-polarized light component) and the transmitting light (P-polarized light component) from the PBS 6 can be changed by rotating the first retardation plate 5 to change the light amount ratio between the S-polarized light component and the P-polarized light component of the blue light 4B.

The blue light 4B as S-polarized light reflected by the PBS 6 passes through the first lens 7 and illuminates the phosphor wheel 8 as a wavelength converter. The first lens 7 condenses the blue light 4B to form a light irradiation area of a predetermined size on the phosphor wheel 8. The phosphor wheel 8 is formed by applying the phosphor on the substrate wheel in an annular shape in the circumferential direction or on the entire surface. The phosphor wheel 8 is rotated at a predetermined rotation speed by the phosphor wheel motor 9 in order to prevent the conversion efficiency from lowering due to the irradiation of the blue light 4B to one location. A nonrotating phosphor wheel may be used.

The phosphor converts the wavelength (fluorescence conversion) of at least part of the blue light 4B as the excitation light, and emits the fluorescent light 4Y as yellow light (light in the third wavelength band). The phosphor is made, for example, of YAG:Ce. The substrate wheel of the phosphor wheel 8 may be highly rigid, have a high reflectance to yellow light, and easily radiates heat generated by the phosphor, like a metal plate such as aluminum. The yellow fluorescent light 4Y from the phosphor wheel 8 is incident on the first lens 7 and collimated, and enters the polarization beam splitter 6 again.

On the other hand, the blue light 4B emitted as the P-polarized light from the first retardation plate 5 passes through the polarization beam splitter 6, and is irradiated onto the diffusion wheel 12 via the second retardation plate 10 and the second lens 11. The second retardation plate 10 serves as a quarter waveplate for the blue light 4B, and converts the blue light 4B as the P-polarized light into circularly polarized light. The second lens 11 condenses the blue light 4B emitted from the second retardation plate 10 and forms a light irradiation area of a predetermined size on the diffusion wheel 12. The diffusion wheel 12 is rotated at a predetermined rotation speed by the diffusion wheel motor 13. The diffusion wheel 12 reduces speckles generated in an image projected by the projector by diffusing the blue light 4B. The substrate wheel of the diffusion wheel 12 may be made of a material that diffuses light, has high rigidity, high light reflectance, and easily radiates heat, such as a metal plate of aluminum or the like.

The blue light 4B diffused by the diffusion wheel 12 is collimated by the second lens 11, converted into the S-polarized light by the second retardation plate 10, and reenters the polarization beam splitter 6. On the polarization splitting surface of the polarization beam splitter 6, the yellow fluorescent light 4Y from the phosphor wheel 8 transmits it, and the blue light 4B from the diffusion wheel is reflected. In this way, the yellow fluorescent light 4Y and the blue light 4B are combined, and enter the first dichroic mirror 14 as a light combiner.

The red light 4R as the P-polarized light emitted from the red light source 3, which is the second light source, enters the first dichroic mirror 14 via the diffusion plate 15 and the third lens 16. The diffusion plate 15 reduces the above speckles by diffusing the red light 4R. The third lens 16 converts the red light 4R diffused by the diffusion plate 15 into parallel light.

FIG. 1B illustrates the spectral characteristics of the first dichroic mirror 14. As illustrated in FIG. 1B, the first dichroic mirror 14 transmits the blue light 4B and the yellow fluorescent light 4Y and reflects the red light 4R. Hence, the first dichroic mirror 14 combines the blue light 4B and the yellow fluorescent light 41 from the polarization beam splitter 6 with the red light 4R from the red light source 3 and emits them as illumination light 17 to the illumination optical system.

In this embodiment, the wavelength band of the red light 4R is included in part of the wavelength band of the yellow fluorescent light 4Y. Thus, when the first dichroic mirror 14 combines the yellow fluorescent light and the red light with each other, a component (red component) of part of the wavelength band of the yellow fluorescent light does not pass the first dichroic mirror 14 and is cut. The combination in this embodiment may include the combination of the yellow fluorescent light 4Y and the red light 4R from which some of the spectral components have been cut.

The illumination light 17 is split into a plurality of light fluxes while passing through the first fly-eye lens 18 and the second fly-eye lens 19 and enters the polarization conversion element 20. The polarization conversion element 20 converts the illumination light 17 including the fluorescent light 41 as unpolarized light from the phosphor wheel 8 into linearly polarized light having a specific polarization direction (S-polarized light in this embodiment). A plurality of light beams as the illumination light 17 emitted from the polarization conversion element 20 are condensed by the fourth lens 21 and superimposed on the light modulation elements (26R, 26G, and 26B). Thereby, each light modulation element is uniformly illuminated.

The illumination light 17 that has transmitted through the fourth lens 21 enters the second dichroic mirror 22. The second dichroic mirror 22 reflects the red and blue light 17RB in the illumination light 17 and transmits the green light (light in the fourth wavelength band) 17G. The green light 17G as the S-polarized light that has transmitted through the second dichroic mirror 22 enters the G polarization beam splitter 24G, is reflected on its polarization splitting surface, and enters the G light modulation element 26G. Each of the light modulation elements (26R, 26G, and 26B) is a reflection type liquid crystal panel. The G light modulation element 26G modulates and reflects the green light 17G. The S-polarized light component of the image-modulated green light 17G is reflected by the polarization splitting surface of the G polarization beam splitter 24G, returned to the light source side, and removed from the projection light.

On the other hand, the P-polarized light component of the modulated green light 17G passes through the polarization splitting surface in the G polarization beam splitter 24G. At this time, where all the polarization components are converted into the S-polarized light (where black is displayed), the slow axis (or the fast axis) of the quarter waveplate 25G is adjusted to a direction orthogonal to the plane that includes the incident optical path to the G polarization beam splitter 24G and the reflection optical path from it. Thereby, the disorder of the polarization state generated by the G polarization beam splitter 24G and the G light modulation element 26G can be suppressed. The green light 17G emitted from the G polarization beam splitter 24G enters the color combining prism 27 and is reflected from it.

The red and blue light 17RB reflected by the second dichroic mirror 22 enters the wavelength selective phase plate 23. The wavelength selective phase plate 23 rotates the polarization direction of the red light by 90° to convert it into the P-polarized light, and transmits the blue light as the S-polarized light in the same polarization direction. The red and blue light 17RB transmitted through the wavelength selective phase plate 23 enters the RB polarization beam splitter 24RB. The RB polarization beam splitter 24RB transmits the red light 17R as the P-polarized light and reflects the blue light 17B as the S-polarized light.

The red light 17R that has transmitted through the polarization splitting surface in the RB polarization beam splitter 24RB is modulated and reflected by the R light modulation element 26R. The P-polarized light component of the modulated red light 17R passes through the polarization splitting surface in the RB polarization beam splitter 24RB, returns to the light source side, and is removed from the projection light. On the other hand, the S-polarized light component of the modulated red light 17R is reflected by the polarization splitting surface in the RB polarization beam splitter 24RB, enters the color combining prism 27, and transmits it.

The blue light 17B reflected by the polarization splitting surface in the RB polarization beam splitter 24RB is modulated and reflected by the B light modulation element 26B. The S-polarized light component of the modulated blue light 17B is reflected by the polarization splitting surface in the RB polarization beam splitter 24RB, returned to the light source side, and removed from the projection light. On the other hand, the P-polarized light component of the modulated blue light 17B passes through the polarization splitting surface in the RB polarization beam splitter 24RB, enters the color combining prism 27, and transmits it. At this time, by adjusting the slow axes of the quarter waveplates 25R and 25B in the same manner as that of the quarter waveplate 25G, the disturbances of the polarization states generated by the RB polarization beam splitter 24RB and R and the G light modulation elements 26R and 26B can be suppressed.

Thus, the red light 17R, the green light 17G, and the blue light B combined into one light beam in the color combining prism 27 are projected as projection light 28 via a projection lens 29 onto a screen 30 which is a projection surface. Thereby, a color image as a projection image is displayed on the screen 30. The optical path illustrated in FIG. 1A is one when the projector displays an all-white image, and in other embodiments described later, unless otherwise specified, the projector displays the all-white image.

In addition to the blue light source 2 that emits the blue light and the phosphor that emits the yellow fluorescent light, this embodiment can supplement the red light that would run short with the yellow fluorescent light alone by using the red light source 3 that emits red light. Hence, when the all-white image is displayed, it is unnecessary to reduce the green light amount and the blue light amount used to project the image according to the insufficient red light (for example, to reduce the maximum modulation amounts in the green and blue light modulation elements according to the red light amount). As a result, the light use efficiency can be improved.

### Second Embodiment

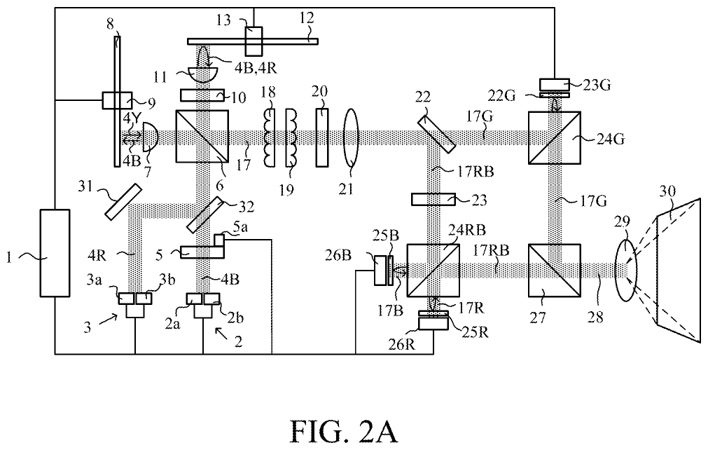

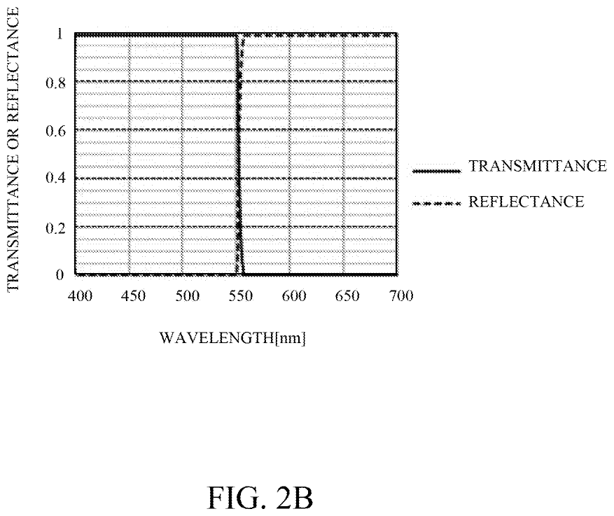

FIG. 2A illustrates a configuration of a projector including a light source apparatus according to a second embodiment of the present invention. The light source apparatus according to this embodiment is different from that of the projector of the first embodiment in position of the red light source 3, no first dichroic mirror 14 provided, and a first mirror 31 and a third dichroic mirror 32 newly provided. In this embodiment and other embodiments described later, those elements common to the first embodiment will be designated by the same reference numerals as in the first embodiment, and a description thereof will be omitted. The configuration after the illumination optical system in this embodiment is the same as that of the first embodiment.

The red light 4R as the P-polarized light emitted from the red light source 3 is reflected by the first mirror 31 and guided to the third dichroic mirror 32 as a light combiner. FIG. 2B illustrates the spectral characteristic of the third dichroic mirror 32. As illustrated in FIG. 2B, the third dichroic mirror 32 transmits the blue light 4B that has been emitted from the blue light source 2 and has transmitted through the first retardation plate 5, reflects the red light 4R, and combines them with each other. The combined blue light 4B and red light 4R enter the polarization beam splitter 6. The optical path of the blue light 4B after the polarization beam splitter 6 is the same as that in the first embodiment.

The red light 4R incident as the P-polarized light on the polarization beam splitter 6 transmits the polarization beam splitter 6, is converted into the circularly polarized light by the second retardation plate 10 serving as a quarter waveplate for the blue light 4B and the red light 4R, is condensed by the second lens 11, and is irradiated to form a light irradiation area of a predetermined size on the diffusion wheel 12. In other words, the red light 4R as well as the blue light 4B are diffused by the diffusion wheel 12 in order to reduce speckles in the projection image as described in the first embodiment.

The red light 4B diffused by the diffusion wheel 12 is collimated by the second lens 7, and converted into the S-polarized light by the second retardation plate 10. The red light 4B converted into the S-polarized light again enters the polarization beam splitter 6, and is reflected by the polarization splitting surface. The yellow fluorescent light 4Y from the phosphor wheel 8 and the red light 4B from the diffusion wheel 12 are combined with each other by the polarization beam splitter 6 and emitted as the illumination light 17 from the light source apparatus to the illumination optical system.

This embodiment can make compact the light source apparatus and the projector by diffusing the blue light 4B and the red light 4R with the common diffusion wheel 12.

### Third Embodiment

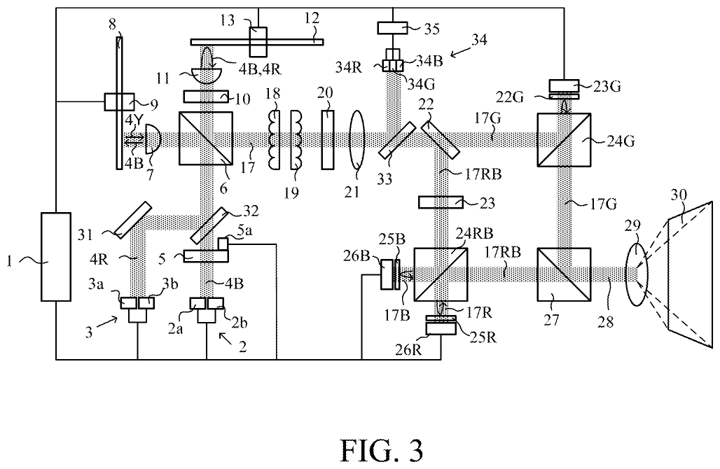

FIG. 3 illustrates a configuration of a projector according to a third embodiment of the present invention. The projector of this embodiment is similar to that of the second embodiment with respect to the light source apparatus, but is different from that of the second embodiment in a light branching unit 33, a light measuring unit 34, and a calculator 35. The light measuring unit 34 and the calculator 35 constitute a light amount detector. The configuration after the illumination optical system in this embodiment is the same as that of the first embodiment.

The light branching unit 33 includes a flat glass, and reflects part of the projection light 17 from the fourth lens 21 toward the second dichroic mirror 22 to guide it to the light measuring unit 34. The light measuring unit 34 is provided to detect a change in the color balance of the illumination light 17 due to environmental temperature changes or the aging deteriorations of various components, and includes R, G, and B light measuring units 34R, 34G, and 34B each including a photodiode.

The B light measuring unit 34B measures (detects) a blue light amount of the illumination light 17 having a wavelength in a range of 445 nm to 465 nm (first light amount). The R light measuring unit 34R measures a red light amount of the illumination light 17 having a wavelength in a range of 630 nm to 650 nm (second light amount). The G light measuring unit 34G measures a green light amount of the illumination light 17 having a wavelength in a range of 500 nm to 600 nm. The light measuring unit 34 may make a measurement after output fluctuations of each light source caused by the temperature changes inside the projector become sufficiently small. The measurement results of the R, G, and B light measuring units 34R, 34G, and 34B are sent to the calculator 35.

The calculator 35 makes calculations necessary to correct the color balance of the projection image using the measurement results of the R, G, and B light measuring units 34R, 34G, and 34B. The controller 1 performs color correction processing according to the calculation result of the calculator 35.

The controller 1 performs color correction processing for controlling the light modulation in the R, G, and B light modulation elements 26R, 26G, and 26B and emissions of the blue and red light sources 2 and 3 according to the calculation result.

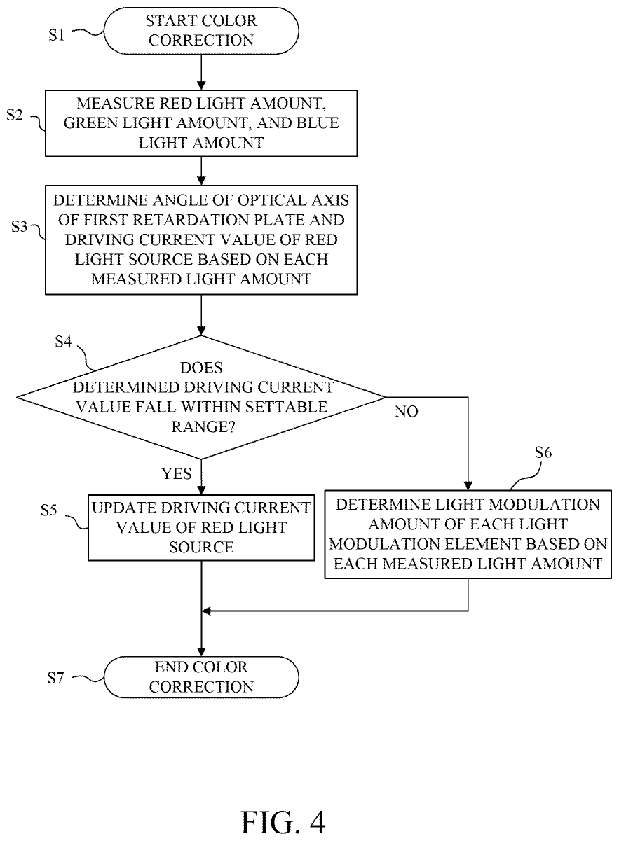

FIG. 4 illustrates the color correction processing performed by the controller 1 according to this embodiment. The controller 1 executes this processing according to a computer program. The controller 1 starts the color correction processing in the step (labelled by Sin the FIG. 1. The timing of performing the color correction process may be determined by the user of the projector, or may be set to a predetermined timing. It may be performed constantly (periodically) during the operation of the projector. This is applied to other embodiments described later.

Next, in the step 2, the controller 1 causes the R, G, and B light measuring units 34R, 34G, and 34B to measure the red light amount, the green light amount, and the blue light amount, respectively.

Next, in the step 3, the controller 1 causes the calculator 35 to determine (set) the direction (angle) of the optical axis of the first retardation plate 5 and the driving current value of the red light source 3 (or the light emission amount of the red light source 3) in accordance with the measured red light amount, green light amount, and blue light amount. For example, when the ratio of the green light amount to the blue light amount is larger than a predetermined value, the first retardation plate 5 is rotated so as to reduce the excitation light amount branched by the polarization beam splitter 6 and guided to the phosphor wheel 8. Conversely, when the ratio of the green light amount to the blue light amount is smaller than the predetermined value, the first retardation plate 5 is rotated so as to increase the excitation light amount branched by the polarization beam splitter 6 and guided to the phosphor wheel 8. When the ratio of the red light amount to the green light amount is larger than the predetermined value, the driving current of the red light source 3 is reduced. When the ratio of the red light amount to the green light amount is smaller than the predetermined value, the driving current of the red light source 3 is increased. The drive current of the red light source 3 may be determined from the ratio of the red light amount to the blue light amount.

Next, in the step 4, the controller 1 determines whether the driving current value of the red light source 3 determined in the step 3 falls within a settable range. If the driving current value falls within the settable range, the flow proceeds to the step 5, and if not, the flow proceeds to the step 6.

In the step 5, the controller 1 sets (updates) the driving current value of the red light source 3 to the driving current value determined in the step 3, and ends the color correction processing in the step 7.

On the other hand, in the step 6, the controller 1 determines (or sets) the light modulation amounts of the R, G, and B light modulation elements 26R, 26G, and 26B according to the red light amount, the green light amount, and the blue light amount measured in the step 2. The light modulation amount is a ratio of the intensity of light used as the projection light to the intensity of each color light incident on the light modulation element, and has a value given to each pixel. For example, the light modulation amount of each light modulation element is adjusted such that the white balance of the projection light calculated from the red light amount, the green light amount, and the blue light amount falls within a predetermined range. Then, in the step 7, the color correction processing ends.

The projector according to this embodiment can properly correct the color balance even when the color balance of the illumination light 17 changes due to the environmental temperature changes or aging deteriorations of various components.

### Fourth Embodiment

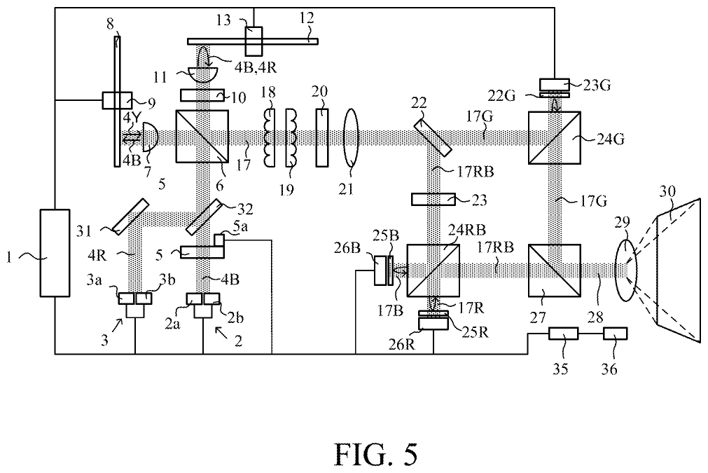

FIG. 5 illustrates a configuration of a projector according to a fourth embodiment of the present invention. The projector according to this embodiment is similar to that of the second embodiment with respect to the light source apparatus, but is different from that of the second embodiment in a camera 36 and a calculator 35. The camera 36 and the calculator 35 constitute a light amount detector. The configuration after the illumination optical system in this embodiment is the same as that of the first embodiment.

The camera 36 captures the projection image displayed on the screen 30 and sends the data of the captured image obtained by imaging to the calculator 35. The calculator 35 calculates the red light amount, the green light amount, and the blue light amount in the projection image from the captured image data, and performs an operation necessary to correct the color balance of the projection image using these calculation results. The controller 1 performs color correction processing according to the calculation result of the calculator 35.

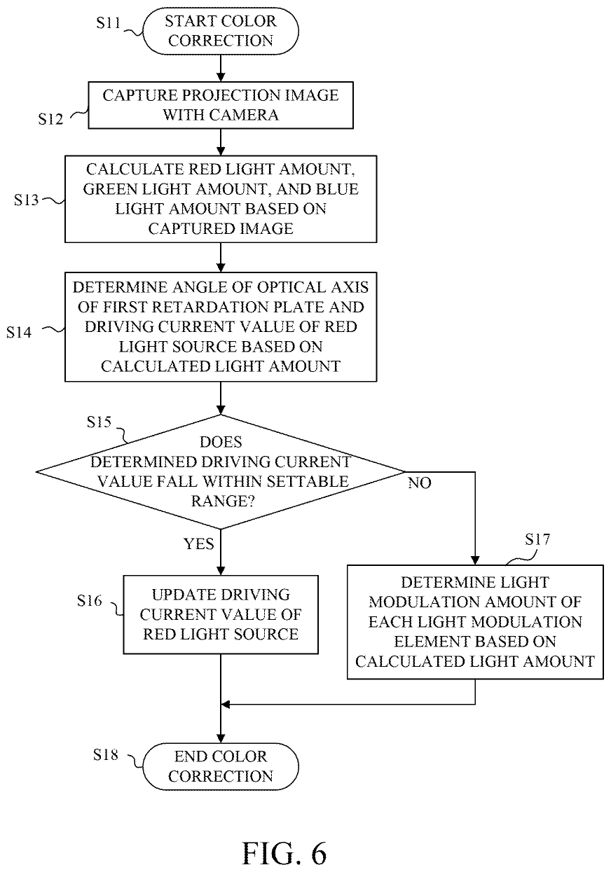

FIG. 6 illustrates the color correction processing performed by the controller 1 according to this embodiment. The controller 1 executes this processing according to a computer program. The controller 1 that has started the color correction processing in the step 11 causes the camera 36 to capture the projection image displayed on the screen 30 in the step 12. The projection image at this time may be an image suitable to calculate each color light amount, such as an all-white image, an all-red, an all-green, and an all-blue image.

Next, in the step 13, the controller 1 causes the calculator 35 to calculate the red light amount, the green light amount, and the blue light amount in the projection image using the captured image data obtained from the camera 36.

Next, in the step 14, the controller 1 causes the calculator 35 to determine (set) the direction (angle) of the optical axis of the first retardation plate 5 and the driving current value of the red light source 3 (or the light emission amount of the red light source 3) in accordance with the calculated red light amount, green light amount, and blue light amount, similar to the step 3 in the third embodiment.

The subsequent steps 15 to 18 are the same as the steps 4 to 7 described in the third embodiment (FIG. 4), respectively.

This embodiment performs the color correction processing including the characteristic of the screen 30 by correcting the color balance of the projection image using the captured image data obtained by directly capturing the projection image with the camera 36.

The first to fourth embodiments use the retardation plate (first retardation plate 5) as the light amount ratio changer, but may use another measure other than the retardation plate as long as a light amount ratio of the two polarized light components can be changed.

Each of the above embodiments can provide a light source apparatus and a projector, each of which can improve the light use efficiency in projecting an image.

### OTHER EMBODIMENTS

Embodiment(s) of the present invention can also be realized by a computer of a system or apparatus that reads out and executes computer executable instructions (e.g., one or more programs) recorded on a memory medium (which may also be referred to more fully as a ‘non-transitory computer-readable memory medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the memory medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the memory medium. The memory medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™) a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2019-078975, filed on Apr. 18, 2019 and 2020-061936, filed on Mar. 31, 2020, which are hereby incorporated by reference herein in their entirety

What is claimed is:

1. A light source apparatus comprising:
a first light source configured to emit light in a first wavelength band;
a second light source configured to emit light in a second wavelength band different from the first wavelength band;
a light amount ratio changer configured to change a light amount ratio between a first polarized light component and a second polarized light component having different polarization directions in light of the first wavelength band;
a polarization beam splitter configured to split the first polarized light component and the second polarized light component from the light amount ratio changer;
a wavelength converter configured to convert the light of the first wavelength band obtained from the first polarized light component from the polarization beam splitter, into light in a third wavelength band including the second wavelength band; and
a light combiner configured to combine light in the first wavelength band and light in the second wavelength band with each other.

2. The light source apparatus according to claim 1, wherein the light combiner is located on an optical path between the first light source and the polarization beam splitter.

3. The light source apparatus according to claim 1, wherein the light combiner is located on an optical path between the second light source and the polarization beam splitter.

4. The light source apparatus according to claim 1, wherein the light amount ratio changer is a retardation plate, and the retardation plate is rotatable around an axis extending in the traveling direction of the light in the first wavelength band.

5. The light source apparatus according to claim 1, further comprising a diffuser configured to diffuse the second polarization component from the polarization beam splitter

6. The light source apparatus according to claim 5, wherein the diffuser also diffuses the light in the second wavelength band which is incident as polarized light.

7. The light source apparatus according to claim 1, wherein the first wavelength band is a blue wavelength band, the second wavelength band is a red wavelength band, and the third wavelength band includes the red wavelength band and a green wavelength band.

8. The light source apparatus according to claim 1, further comprising a light amount detector configured to measure or calculate a light amount of the first wavelength band, a light amount of the second wavelength band, and a light amount of a fourth wavelength band different from the second wavelength band in the third wavelength band, after a combination by the light combiner; and
a controller configured to setting at least one of a direction of an optical axis of the light amount ratio changer and the light emission amount of the second light source according to a measurement result or calculation result of the light amount detector.

9. The light source apparatus according to claim 8, wherein the controller:
sets the direction of the optical axis according to the light amount of the first wavelength band and the light amount of the fourth wavelength band, and
sets a light emission amount of the second light source according to at least one of the light amount of the first wavelength band and the light amount of the fourth wavelength band.

10. The light source apparatus according to claim 1, wherein the light combiner combines the light in the first wavelength band and the light in the third wavelength band with each other, and then further combines the light in the second wavelength band with resultant light.

11. The light source apparatus according to claim 1, wherein the light combiner combines the light in the first wavelength band and the light in the second wavelength band with each other, and then combines the light in the third wavelength band with resultant light.

12. An image projection apparatus comprising:
a light source apparatus; and
a light modulation element configured to modulates light from the light source apparatus, the image projection apparatus being configured to project light modulated by the light modulation element and to display an image,
wherein the light source apparatus includes:
a first light source configured to emit light in a first wavelength band;
a second light source configured to emit light in a second wavelength band different from the first wavelength band;
a light amount ratio changer configured to change a light amount ratio between a first polarized light component and a second polarized light component having different polarization directions in light of the first wavelength band;
a polarization beam splitter configured to split the first polarized light component and the second polarized light component from the light amount ratio changer;
a wavelength converter configured to convert the light of the first wavelength band obtained from the first polarized light component from the polarization beam splitter, into light in a third wavelength band including the second wavelength band; and
a light combiner configured to combine light in the first wavelength band and light in the second wavelength band with each other.
